(19) United States
(12) Patent Application Publication
(10) Pub. No.: US 2005/0259105 A1
(43) Pub. Date: Nov. 24, 2005

(54) System and method for detecting memory location modifications to initiate image data transfers

(76) Inventors: Juraj Bystricky, Richmond (CA); Keith Edward Gillett, Delta (CA); Atousa Soroushi, North Vancouver (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/848,719

(22) Filed: May 19, 2004

(51) Int. Cl. G09G 5/36

(52) U.S. Cl. 345/559

(57) ABSTRACT

A system and method for detecting memory location modifications to initiate image data transfers includes a display controller device with a location detector module and controller logic. The location detector module detects register write operations from a host central-processing unit to on-screen registers in a controller registers of the display controller. The on-screen registers define where in a video memory of the display controller the on-screen data is stored. The location detector module responsively sets a transfer flag to indicate that one or more memory locations of the on-screen data have been modified. The controller logic then detects that the transfer flag has been set by the location detector module. The controller logic may then efficiently initiate a frame transfer operation for transferring the appropriate on-screen data from the video memory to a display of a host electronic device.

### BACKGROUND SECTION

1. Field of Invention

This invention relates generally to electronic display controller systems, and relates more particularly to a system and method for detecting memory location modifications to initiate image data transfers.

2. Description of the Background Art

Implementing efficient methods for displaying electronic image data is a significant consideration for designers and manufacturers of contemporary electronic devices. However, efficiently displaying image data with electronic devices may create substantial challenges for system designers. For example, enhanced demands for increased device functionality and performance may require more system operating power and require additional hardware resources. An increase in power or hardware requirements may also result in a corresponding detrimental economic impact due to increased production costs and operational inefficiencies.

Furthermore, enhanced device capability to perform various advanced display control operations may provide additional benefits to a system user, but may also place increased demands on the control and management of various device components. For example, an enhanced electronic device that efficiently manipulates, transfers, and displays digital image data may benefit from an efficient implementation because of the large amount and complexity of the digital data involved.

Due to growing demands on system resources and substantially increasing data magnitudes, it is apparent that developing new techniques for controlling the display of electronic image data is a matter of concern for related electronic technologies. Therefore, for all the foregoing reasons, developing efficient systems for displaying electronic image data remains a significant consideration for designers, manufacturers, and users of contemporary electronic devices.

### SUMMARY

In accordance with the present invention, a system and method are disclosed for detecting memory location modifications to initiate image data transfers. In certain embodiments, an electronic device may be implemented to include a central-processing unit (CPU), one or more displays, and a display controller. A location detector module of the display controller initially monitors on-screen registers that define specific storage locations of on-screen data in a video memory of the display controller.

If the location detector module determines that a modification to the on-screen registers has occurred to thereby change one or more memory locations of on-screen data, then the location detector module responsively sets a transfer flag in controller registers of the display controller to indicate that at least one memory location of the on-screen data has been modified. Finally, in response to the foregoing transfer flag, controller logic of the display controller may initiate a corresponding transfer operation to provide a frame of the on-screen data from the display controller to a display of the host electronic device. In various embodiments, the foregoing transfer operation may be automatically performed by the controller logic of the display controller, or alternately may be coordinated by the CPU and appropriate system software. The present invention therefore provides an improved system and method for detecting memory location modifications to initiate image data transfers.

### BRIEF DESCRIPTION OF THE DRAWINGS

FIG. 1 is a block diagram for one embodiment of an electronic device, in accordance with the present invention;

FIG. 2 is a block diagram for one embodiment of the display controller of FIG. 1, in accordance with the present invention;

FIG. 3 is a block diagram for one embodiment of the video memory of FIG. 2, in accordance with the present invention;

FIG. 4 is a block diagram for one embodiment of the controller registers of FIG. 2, in accordance with the present invention;

FIG. 5 is a block diagram for one embodiment of the display of FIG. 1, in accordance with the present invention;

FIG. 6 is a block diagram for one embodiment of the on-screen data of FIG. 3, in accordance with the present invention;

FIG. 7 is a block diagram for one embodiment of the on-screen registers of FIG. 4, in accordance with the present invention;

FIG. 8 is a flowchart of method steps for performing transfer operations, in accordance with one embodiment of the present invention; and

FIG. 9 is a flowchart of method steps for performing an on-screen memory location monitoring procedure, in accordance with one embodiment of the present invention.

### DETAILED DESCRIPTION

The present invention relates to an improvement in display controller systems. The following description is presented to enable one of ordinary skill in the art to make and use the invention, and is provided in the context of a patent application and its requirements. Various modifications to the embodiments disclosed herein will be apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for detecting memory location modifications to initiate image data transfers, and includes a display controller device with a location detector module and controller logic. The location detector module detects register write operations from a host central-processing unit to on-screen registers in a controller registers of the display controller. The on-screen registers define where in a video memory of the display controller the on-screen data is stored.

The location detector module responsively sets a transfer flag to indicate that one or more memory locations of the on-screen data have been modified. The controller logic then detects that the transfer flag has been set by the location detector module. The controller logic may then efficiently initiate a frame transfer operation for transferring the appropriate on-screen data from the video memory to a display of a host electronic device.

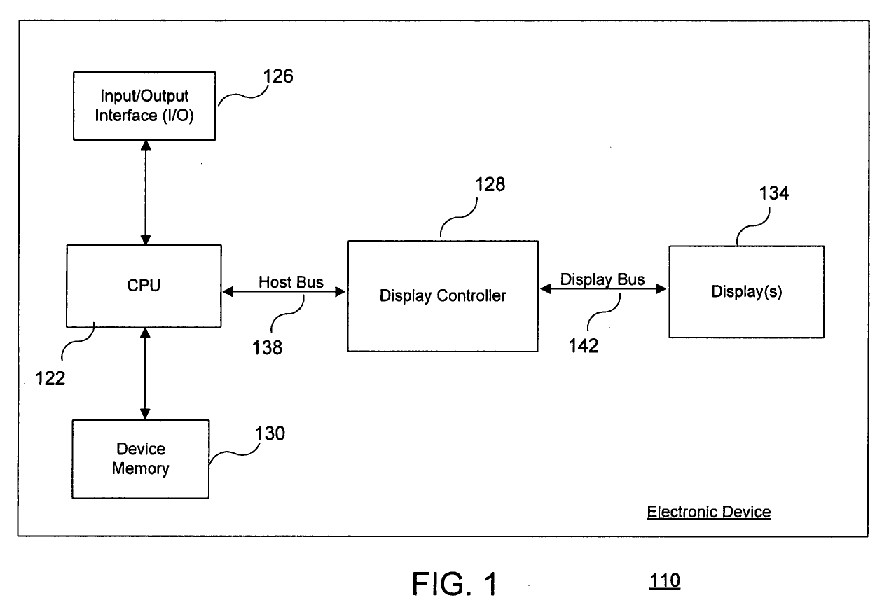

Referring now to FIG. 1, a block diagram for one embodiment of an electronic device 110 is shown, according to the present invention. The FIG. 1 embodiment includes, but is not limited to, a central processing unit (CPU) 122, an input/output interface (I/O) 126, a display controller 128, a device memory 130, and one or more display(s) 134. In alternate embodiments, electronic device 110 may include elements or functionalities in addition to, or instead of, certain of the elements or functionalities discussed in conjunction with the FIG. 1 embodiment.

In the FIG. 1 embodiment, CPU 122 may be implemented as any appropriate and effective processor device or microprocessor to thereby control and coordinate the operation of electronic device 110 in response to various software program instructions. In the FIG. 1 embodiment, device memory 130 may comprise any desired storage-device configurations, including, but not limited to, random access memory (RAM), read-only memory (ROM), and storage devices such as removable memory or hard disk drives. In the FIG. 1 embodiment, device memory 130 may include, but is not limited to, a device application of program instructions that are executed by CPU 122 to perform various functions and operations for electronic device 110. The particular nature and functionality of the device application typically varies depending upon factors such as the type and specific use of the corresponding electronic device 110.

In the FIG. 1 embodiment, the foregoing device application may include program instructions for allowing CPU 122 to provide image data and corresponding transfer and display information via host bus 138 to display controller 128. In accordance with the present invention, display controller 128 then responsively provides the received image data via display bus 142 to at least one of the display(s) 134 of electronic device 110. In the FIG. 1 embodiment, input/output interface (I/O) 126 may include one or more interfaces to receive and/or transmit any required types of information to or from electronic device 110. Input/output interface 126 may include one or more means for allowing a device user to communicate with electronic device 110. In addition, various external electronic devices may communicate with electronic device 110 through I/O 126. For example, a digital imaging device, such as a digital camera, may utilize input/output interface 126 to provide captured image data to electronic device 110.

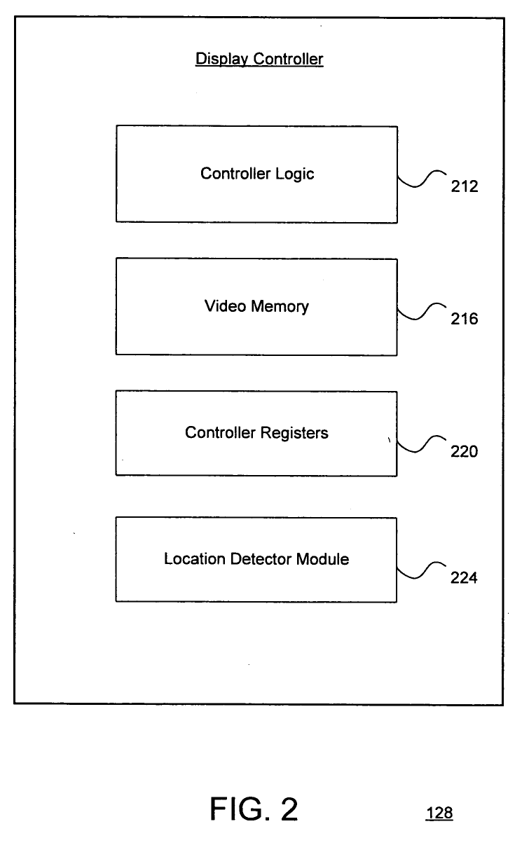

In the FIG. 1 embodiment, electronic device 110 may advantageously utilize display controller 128 for efficiently managing various operations and functionalities relating to display(s) 134. The implementation and functionality of display controller 128 is further discussed below in conjunction with FIGS. 2-4 and 6-9. In the FIG. 1 embodiment, electronic device 110 may be implemented as any desired type of electronic device or system. For example, in certain embodiments, electronic device 110 may alternately be implemented as a cellular telephone; a personal digital assistant device, an electronic imaging device, a cellular telephone, or a computer device. Various embodiments for the operation and utilization of electronic device 110 are further discussed below in conjunction with FIGS. 2-9.

Referring now to FIG. 2, a block diagram for one embodiment of the FIG. 1 display controller 128 is shown, according to the present invention. The FIG. 2 embodiment includes, but is not limited to, controller logic 212, video memory 216, controller registers 220, and a location detector module 224. In alternate embodiments, display controller 128 may include elements or functionalities in addition to, or instead of, certain of the elements or functionalities discussed in conjunction with the FIG. 2 embodiment.

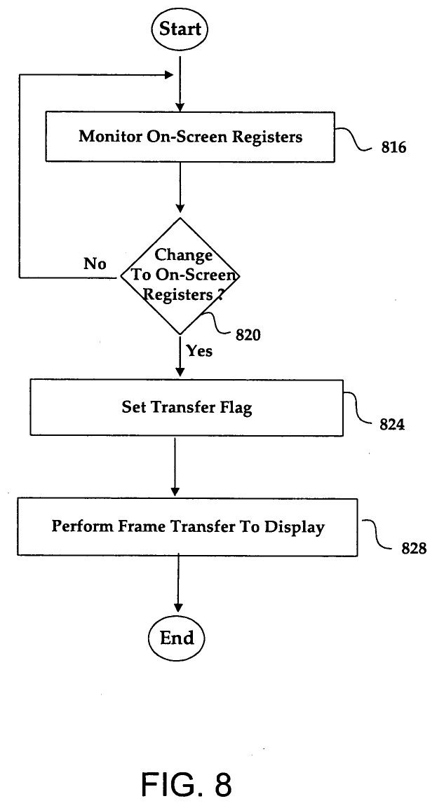

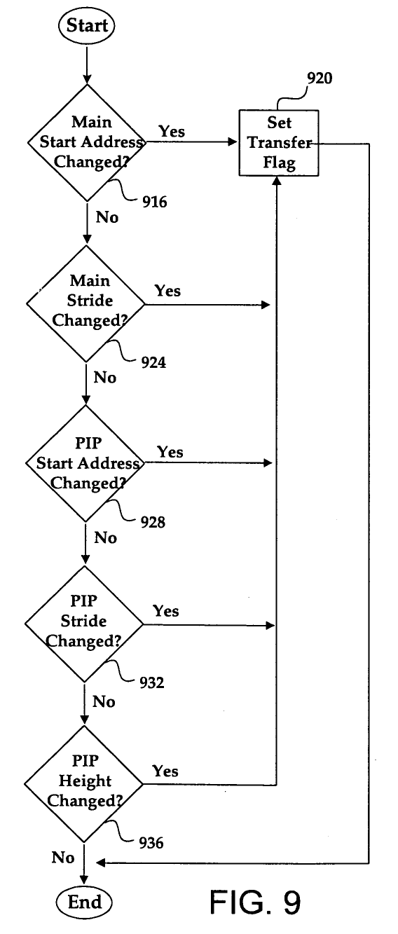

In the FIG. 2 embodiment, display controller 128 may be implemented as an integrated circuit device that accepts image data and corresponding transfer and display information from CPU 122 (FIG. 1). Display controller 128 then automatically provides the received image data to display 134 of electronic device 110 in an appropriate and efficient manner for displaying to a device user. In the FIG. 2 embodiment, controller logic 212 manages the overall operation of display controller 128. In certain embodiments, controller logic 212 may include, but is not limited to, an image creation module and a transfer module. The image creation module manages reading image data from video memory 216, and forming corresponding image pixels for display according to information from controller registers 220. The transfer module performs image data transfer operations to provide the foregoing image pixels to display 134 (FIG. 1). Certain embodiments for the implementation and utilization of location detector module 224 are further discussed below in conjunction with FIGS. 8-9.

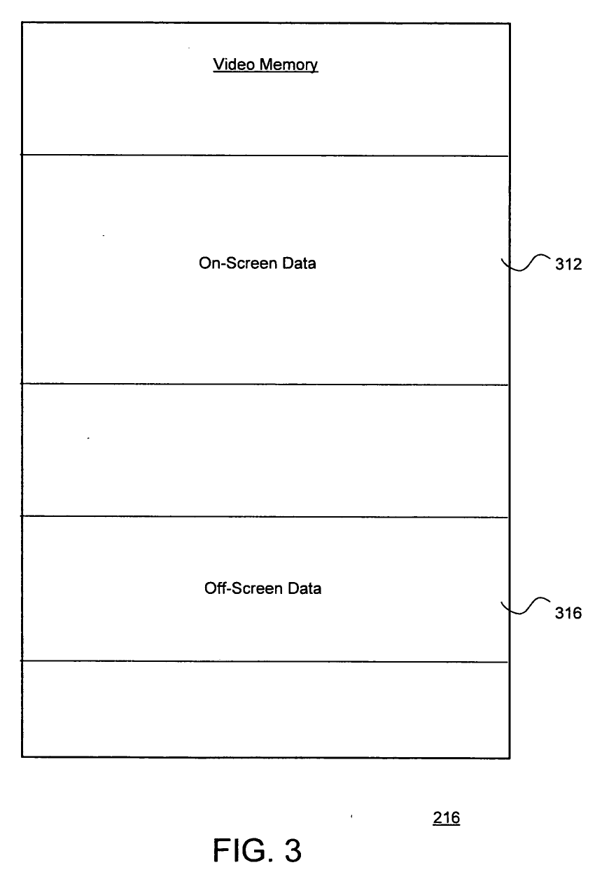

Referring now to FIG. 3, a block diagram for one embodiment of the FIG. 2 video memory 216 is shown, in accordance with the present invention. In the FIG. 3 embodiment, video memory 216 includes, but is not limited to, on-screen data 312 and off-screen data 316. In alternate embodiments, video memory 216 may include elements and functionalities in addition to, or instead of, certain of the elements and functionalities discussed in conjunction with the FIG. 3 embodiment.

In the FIG. 3 embodiment, video memory 216 may be implemented by utilizing any effective types of memory devices or configurations. For example, in certain embodiments, video memory 216 may be implemented as a random-access memory (RAM) device. In the FIG. 3 embodiment, on-screen data 312 and off-screen data 316 are each shown as single contiguous memory blocks in video memory 216. However, in various other embodiments, different components of on-screen data 312 and/or off-screen data 316 may readily be stored as multiple non-contiguous memory blocks within video memory 216.

In the FIG. 3 embodiment, CPU 122 (FIG. 1) writes image data into on-screen data 312 for transfer by display controller 128 to display 134 of electronic device 110 for viewing by a device user. In the FIG. 3 embodiment, on-screen data 312 includes any appropriate type of information for display upon a screen of display 134 (FIG. 1). For example, on-screen data 312 may include main image data corresponding to a main window area on display 134. In addition, on-screen data 312 may include picture-in-picture (PIP) image data corresponding to one or more picture-in-picture window areas that are positioned within the foregoing main window area on display 134.

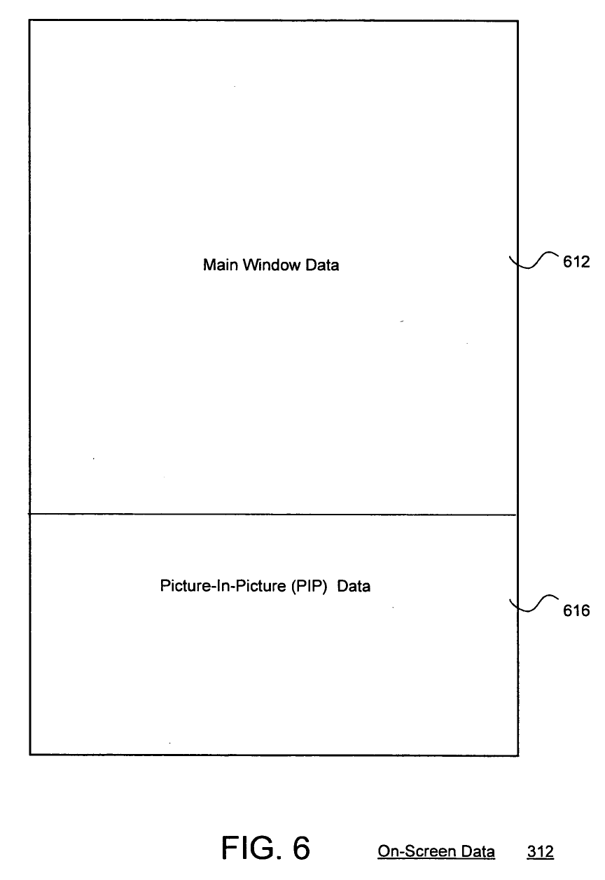

In the FIG. 3 embodiment, off-screen data 316 may include any appropriate type of information or data that is not displayed upon display 134 of electronic device 110. For example, off-screen data 316 may be utilized to support various types of double buffering schemes for display controller 128, or may also be utilized to cache certain fonts or other objects for use by display controller 128. The utilization of video memory 216 is further discussed below in conjunction with FIGS. 6 and 8-9.

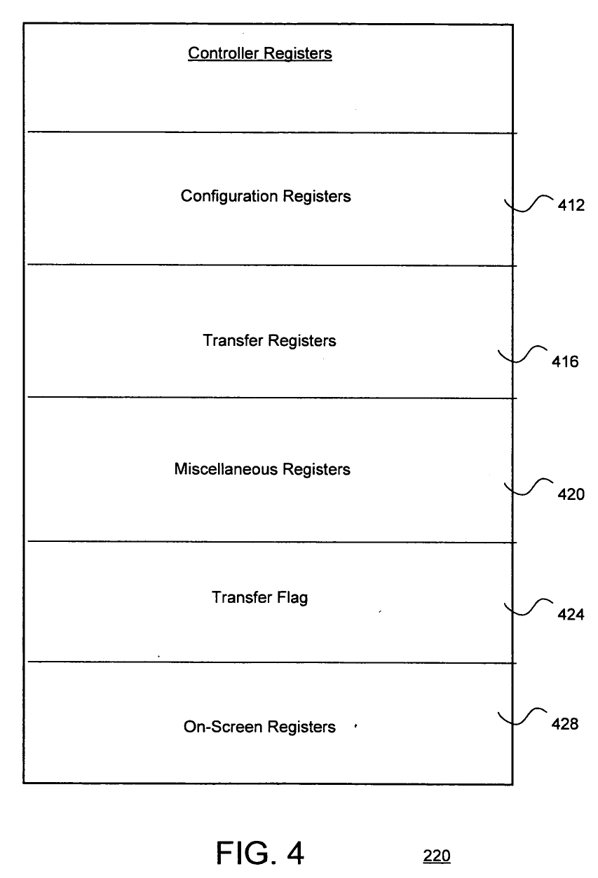

Referring now to FIG. 4, a block diagram for one embodiment of the FIG. 2 controller registers 220 is shown, in accordance with the present invention. In the FIG. 4 embodiment, controller registers 220 include, but are not limited to, configuration registers 412, transfer registers 416, miscellaneous registers 420, a transfer flag 424, and on-screen registers 428. In alternate embodiments, controller registers 220 may include elements and functionalities in addition to, or instead of, certain of the elements and functionalities discussed in conjunction with the FIG. 4 embodiment.

In the FIG. 4 embodiment, CPU 122 (FIG. 1) or other appropriate entities may advantageously write information into controller registers 220 to specify various types of operational parameters and other relevant information for use by configuration logic 212 of display controller 128. In the FIG. 4 embodiment, controller registers 220 may utilize configuration registers 412 for storing various types of information relating to the configuration of display controller 128 and/or display 134 of electronic device 110. For example, configuration registers 220 may specify a display type, a display size, a display frame rate, and various display timing parameters. In the FIG. 4 embodiment, controller registers 220 may utilize transfer registers 416 for storing various types of information relating to transfer operations for providing pixel data from video memory 216 (FIG. 3) to display 134 of electronic device 110.

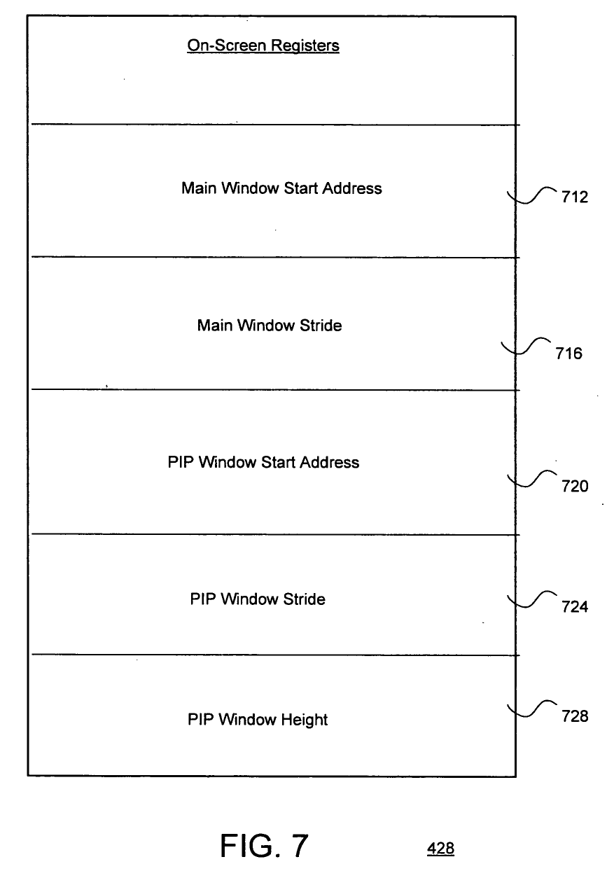

In the FIG. 4 embodiment, controller registers 220 may utilize miscellaneous registers 420 for effectively storing any desired type of information or data for use by display controller 128. In the FIG. 4 embodiment, controller logic 212 (FIG. 2), location detector module 224, or other appropriate entity may set a transfer flag 424 to indicate that certain conditions for triggering a transfer of image data to display 134 have been met. In response, controller logic 212 (FIG. 2) performs a corresponding transfer procedure, as discussed below in conjunction with FIG. 8. In the FIG. 4 embodiment, CPU 122 or other appropriate entity may program on-screen registers 428 to include various types of information regarding specified locations for storing on-screen data 312 in video memory 216. The implementation and utilization of on-screen registers 428 are further discussed below in conjunction with FIGS. 7-9.

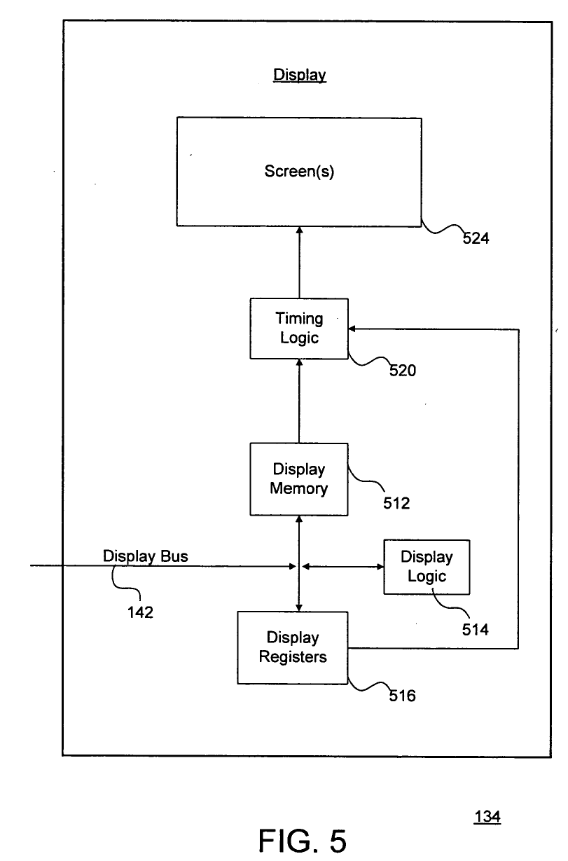

Referring now to FIG. 5, a block diagram for one embodiment of the FIG. 1 display 134 is shown, in accordance with the present invention. In the FIG. 5 embodiment, display 134 includes, but is not limited to, a display memory 512, display logic 514, display registers 516, timing logic 520, and one or more screen(s) 524. In alternate embodiments, display 134 may include elements and functionalities in addition to, or instead of, certain of the elements and functionalities discussed in conjunction with the FIG. 5 embodiment.

In the FIG. 5 embodiment, display 134 is implemented as a random-access-memory based liquid-crystal display panel (RAM-based LCD panel). However, in alternate embodiments, display 134 may be implemented by utilizing any type of appropriate display technologies or configurations. In the FIG. 5 embodiment, display controller 128 provides various types of display information to display registers 516 via display bus 142. Display registers 516 may then utilize the received display information for effectively controlling timing logic 520. In the FIG. 5 embodiment, display logic 514 manages and coordinates data transfer and display functions for display 134.

In the FIG. 5 embodiment, controller logic 212 (FIG. 2) of display controller 128 provides image data from video memory 216 (FIG. 2) to display memory 512 via display bus 142. In the FIG. 5 embodiment, display memory 512 is typically implemented as random-access memory (RAM). However, in various other embodiments, any effective types or configurations of memory devices may be utilized to implement display memory 512. In the FIG. 5 embodiment, display memory 512 then advantageously provides the image data received from display controller 128 to one or more screens 524 via timing logic 520 for viewing by a device user of electronic device 110. Various techniques for efficiently transferring image data to display 134 are further discussed below in conjunction with FIGS. 6 through 9.

Referring now to FIG. 6, a block diagram for one embodiment of the FIG. 3 on-screen data 312 is shown, in accordance with the present invention. In the FIG. 6 embodiment, on-screen data 312 includes, but is not limited to, main window data 612 and picture-in-picture (PIP) data 616. In alternate embodiments, on-screen data 312 may include elements and functionalities in addition to, or instead of, certain of the elements and functionalities discussed in conjunction with the FIG. 6 embodiment. For example, in certain embodiments, electronic device 110 may support more than one PIP window with associated PIP data.

In the FIG. 6 embodiment, on-screen data 312 may include any appropriate type of information for display upon one or more screens 524 of display 134 (FIG. 5). For example, on-screen data 312 may include main window data 612 corresponding to a main window area on display 134. In addition, on-screen data 312 may include picture-in-picture (PIP) data 616 corresponding to one or more picture-in-picture window areas that are positioned within the foregoing main window area on display 134.

In the FIG. 6 embodiment, main window data 612 and PIP data 616 are shown as contiguous memory blocks in on-screen data 312. However, in various other embodiments, main window data 612 and PIP data 616 may readily be stored as non-contiguous memory blocks within video memory 216. The detection of memory location changes for either main window data 612 or PIP data 616 is further discussed below in conjunction with FIGS. 8-9.

Referring now to FIG. 7, a block diagram for one embodiment of the FIG. 4 on-screen registers 428 is shown, in accordance with the present invention. In the FIG. 7 embodiment, on-screen registers 428 include, but are not limited to, a main window start address 712, a main window stride 716, a PIP window start address 720, a PIP window stride 724, and a PIP window height. In alternate embodiments, on-screen registers 428 may include elements and functionalities in addition to, or instead of, certain of the elements and functionalities discussed in conjunction with the FIG. 7 embodiment.

In the FIG. 7 embodiment, CPU 122 or another appropriate entity may program on-screen registers 428 to include information defining specific storage locations in video memory 216 for storing on-screen data 312. For example, in the FIG. 7 embodiment, on-screen registers 428 include a main window start address 712 and a main window stride 716 that specify where in video memory 216 the main window data 612 for the foregoing main window area is stored.

In the FIG. 7 embodiment, main window stride 716 may include any value(s) that define the size of corresponding main window data 612. In certain embodiments, main window data 612 may have a logical size that is greater than the actual displayed main window. Accordingly, the main window stride 716 may be used to calculate the end address of main window data 612 in video memory 216. Although the height of main window is typically a fixed value, in certain embodiments, on-screen registers 428 may include a separate main window height register to specific a selectable height for the displayed main window.

Similarly, in the FIG. 7 embodiment, on-screen registers 428 also include a PIP window start address 720 and a PIP window stride 724 that specify where in video memory 216 the PIP data 612 for the PIP window area is stored. In the FIG. 7 embodiment, PIP window stride 724 may include any value(s) that define the size of corresponding PIP data 616. In certain embodiments, PIP data 616 may have a logical size that is greater than the actual displayed PIP window. Accordingly, the PIP window stride 724 may be used to calculate the end address of PIP data 616 in video memory 216.

In the FIG. 7 embodiment, on-screen registers 428 also include a separate on-screen register defining PIP window height 728 by specifying a selectable height for the displayed PIP window. In certain alternate embodiments, on-screen registers 428 may also include any desired number of additional registers. For example, on-screen registers 428 may include color-depth registers for either the main window or the PIP window to define the number of binary bits used to represent each of the displayed pixels from on-screen data 312.

In the FIG. 7 embodiment, location detector module 224 (FIG. 2) may compare current register values from on-screen registers 418 with known prior register values from on-screen registers 428 to thereby determine whether any memory location modifications have been made with regard to the storage location(s) of on-screen data 428 in video memory 216. If location detector module 224 determines that a storage location of on-screen data 316 has been modified by one or more intervening register write operations to on-screen registers 428, then location detector module 224 responsively sets a transfer flag 424 (FIG. 4) to initiate a current transfer operation.

The present invention therefore allows display controller 128 to advantageously support various types of advanced display functions. For example, in certain embodiments, display controller 128 may support a dual buffering scheme in which CPU 122 alternately writes frames of image data into two different areas of off-screen data 316 in video memory 216. Each of the most-recently written frames of image data may then be alternately transferred to display 134 as on-screen data 312.

Furthermore, display controller 128 may support an animation process in which CPU 122 simultaneously writes a series of frames of image data into off-screen data 316 of video memory 216. Display controller 128 may then sequentially transfer each of the series of frames of image data to display 134 as on-screen data 312. In addition, in certain embodiments, CPU 122 may simultaneously write a large block of image data into off-screen data 316 for subsequent transfer to display 134 as smaller sub-blocks of on-screen data 312 over a given time period. The utilization of on-screen registers 428 is further discussed below in conjunction with FIGS. 8-9.

Referring now to FIG. 8, a flowchart of method steps for performing transfer operations is shown, in accordance with one embodiment of the present invention. The FIG. 8 flowchart is presented for purposes of illustration, and in alternate embodiments, the present invention may utilize steps and sequences in addition to, or instead of, certain of the steps and sequences discussed in conjunction with the FIG. 8 embodiment.

In the FIG. 8 embodiment, in step 816, a location detector module 224 of a display controller 128 monitors on-screen registers 428 for memory location changes by utilizing any effective techniques. In step 820, location detector module 224 determines whether a change to on-screen registers 428 has occurred. For example, in certain embodiments, location detector module 224 determines whether CPU 122 or any other appropriate entity has modified the contents of on-screen registers 428 by comparing known previous on-screen register values with current on-screen register values.

If location detector module 224 determines that any of on-screen registers 428 have been modified to thereby change respective memory locations of main window data 612 or PIP data 616, then in step 824, location detector module 224 responsively sets a transfer flag 424 in controller registers 220. Finally in step 828, in response to the foregoing transfer flag 424, controller logic 212 of display controller 128 may initiate a corresponding transfer operation to provide a frame of image data from on-screen data 312 of display controller 128 to display 134. In various embodiments, the foregoing transfer operation may be automatically performed by controller logic 212 of display controller 128, or alternately may be coordinated by CPU 122 and appropriate system software. The FIG. 8 embodiment therefore provides an improved system and method for detecting memory location modifications to initiate image data transfers.

Referring now to FIG. 9, a flowchart of method steps for performing an on-screen memory location monitoring procedure is shown, in accordance with one embodiment of the present invention. The FIG. 9 flowchart presents one embodiment for determining whether a memory location modification for on-screen data 312 has occurred, as discussed above in conjunction with step 820 of FIG. 8. The FIG. 9 flowchart is presented for purposes of illustration, and in alternate embodiments, the present invention may utilize steps and sequences in addition to, or instead of, certain of the steps and sequences discussed in conjunction with the FIG. 9 embodiment.

In the FIG. 9 embodiment, in step 912, location detector module 224 initially determines whether a main window start address 712 from on-screen registers 428 has changed to indicate a memory location modification for corresponding main window data 612. If the main window start address 712 has changed, then in step 920, location detector module 224 responsively sets a transfer flag 424 in controller registers 220.

However, if main window start address 712 has not changed, then in step 924, location detector module 224 determines whether a main window stride 716 from on-screen registers 428 has changed to indicate a memory location modification for corresponding main window data 612. If the main window stride 716 has changed, then in step 920, location detector module 224 responsively sets a transfer flag 424 in controller registers 220. In certain embodiments, location detector module 224 may also set transfer flag 424 if a main window height value from a main window height register in on-screen registers 428 has changed.

In foregoing step 924, if main window stride 716 has not changed, then in step 928, location detector module 224 determines whether a PIP window start address 720 from on-screen registers 428 has changed to indicate a memory location modification for corresponding PIP data 616. If the PIP window start address 720 has changed, then in step 920, location detector module 224 responsively sets transfer flag 424 in controller registers 220.

However, if PIP window start address 720 has not changed, then in step 932, location detector module 224 determines whether a PIP window stride 724 from on-screen registers 428 has changed to indicate a memory location modification for corresponding PIP data 616. If the PIP window stride 724 has changed, then in step 920, location detector module 224 responsively sets transfer flag 424 in controller registers 220.

However, if PIP window stride 932 has not changed, then in step 936, location detector module 224 determines whether a PIP window height 728 from on-screen registers 428 has changed to indicate a memory location modification for corresponding PIP data 616. If the PIP window height 728 has changed, then in step 920, location detector module 224 responsively sets transfer flag 424 in controller registers 220. If PIP window height 728 has not changed, then the FIG. 9 process may terminate without setting transfer flag 424 to initiate a transfer operation.

The invention has been explained above with reference to certain preferred embodiments. Other embodiments will be apparent to those skilled in the art in light of this disclosure. For example, the present invention may be implemented using certain configurations and techniques other than those described in the embodiments above. Additionally, the present invention may effectively be used in conjunction with systems other than those described above as the preferred embodiments. Therefore, these and other variations upon the foregoing embodiments are intended to be covered by the present invention, which is limited only by the appended claims.

1. A system for handling electronic information, comprising:
a location detector module that detects a register write operation to on-screen registers, said on-screen registers defining memory storage locations for on-screen data in a video memory, said location detector module responsively setting a transfer flag to indicate that said on-screen registers and said memory storage locations of said on-screen data have been modified; and
controller logic that initiates a transfer operation for transferring said on-screen data from said video memory to a data destination whenever said transfer flag has been set by said location detector module.

2. The system of claim 1 wherein said data destination includes a display for a portable electronic device, said display being implemented as a random-access-memory based liquid-crystal display.

3. The system of claim 2 wherein said portable electronic device is implemented as a portable cellular telephone device.

4. The system of claim 1 wherein said controller logic and said location detector module are implemented in a display controller that coordinates said transfer operation.

5. The system of claim 4 wherein said display controller conserves device resources and operating power for a portable electronic device by performing said transfer operation only when memory storage locations for said on-screen data have been modified.

6. The system of claim 4 wherein said display controller is implemented as an integrated circuit device that functions as a transparent interface between a central processing unit and a display of said portable electronic device.

7. The system of claim 1 wherein said location detector module monitors said on-screen registers for said register write operation from a central processing unit of a host electronic device.

8. The system of claim 7 wherein said central processing unit prepares for said transfer operation by programming said on-screen registers to define said memory storage locations for said on-screen data.

9. The system of claim 7 wherein said location detector module determines that said central processing unit has performed said register write operation to modify said on-screen registers and said memory storage locations of said on-screen data in said video memory, said on-screen data including main window data and picture-in-picture data.

10. The system of claim 1 wherein said location detector module determines that said register write operation has occurred within said on-screen registers by comparing current on-screen register information with prior known on-screen register information.

11. The system of claim 1 wherein said on-screen registers store on-screen information for defining said memory storage locations, said on-screen information including a main window start address, a main window stride, a main window height, a picture-in-picture window start address, a picture-in-picture window stride, and a picture-in-picture window height.

12. The system of claim 1 wherein said on-screen registers store on-screen information for defining said memory storage locations, said on-screen information including a main window color-depth register for defining a bit-per-pixel parameter for said main window data, said on-screen information also including a picture-in-picture window color-depth register for defining a bit-per-pixel parameter for said picture-in-picture data

13. The system of claim 1 wherein said location detector module determines that said register write operation has occurred to a main window start address in said on-screen registers, said location detector module responsively setting said transfer flag.

14. The system of claim 1 wherein said location detector module determines that said register write operation has occurred to a main window stride in said on-screen registers, said location detector module responsively setting said transfer flag.

15. The system of claim 1 wherein said location detector module determines that said register write operation has occurred to a main window height in said on-screen registers, said location detector module responsively setting said transfer flag.

16. The system of claim 1 wherein said location detector module determines that said register write operation has occurred to a picture-in-picture window start address in said on-screen registers, said location detector module responsively setting said transfer flag.

17. The system of claim 1 wherein said location detector module determines that said register write operation has occurred to a picture-in-picture window stride in said on-screen registers, said location detector module responsively setting said transfer flag.

18. The system of claim 1 wherein said location detector module determines that said register write operation has occurred to a picture-in-picture window height in said on-screen registers, said location detector module responsively setting said transfer flag.

19. The system of claim 1 wherein said controller logic detects that said location detector module has set said transfer flag, said controller logic responsively initiating a full frame transfer of said on-screen data from said video memory to said data destination, said full frame transfer being automatically performed by an automatic transfer module of said controller logic, said full frame transfer alternately being manually performed by a central processing unit of a host electronic device.

20. The system of claim 1 wherein said location detector module supports a dual buffering scheme in which a central processing unit alternately writes frames of image data into two different areas of off-screen data in said video memory, each most-recently written one of said frames of said image data then being alternately transferred to said data destination as said on-screen data when said transfer flag is set, said location detector module also supporting an animation process in which said central processing unit simultaneously writes a series of said frames of said image data into said off-screen data, said controller logic then sequentially transferring individual frames from said series of frames to said data destination as said on-screen data when said transfer flag is set.

21. A method for handling electronic information, comprising the steps of:
detecting a register write operation to on-screen registers by using a location detector module, said on-screen registers defining memory storage locations for on-screen data in a video memory,
setting a transfer flag with said location detector module to indicate that said on-screen registers and said memory storage locations of said on-screen data have been modified; and
utilizing controller logic to initiate a transfer operation for transferring said on-screen data from said video memory to a data destination whenever said transfer flag has been set by said location detector module.

22. The method of claim 21 wherein said data destination includes a display for a portable electronic device, said display being implemented as a random-access-memory based liquid-crystal display.

23. The method of claim 22 wherein said portable electronic device is implemented as a portable cellular telephone device.

24. The method of claim 21 wherein said controller logic and said location detector module are implemented in a display controller that coordinates said transfer operation.

25. The method of claim 24 wherein said display controller conserves device resources and operating power for a portable electronic device by performing said transfer operation only when memory storage locations for said on-screen data have been modified.

26. The method of claim 24 wherein said display controller is implemented as an integrated circuit device that functions as a transparent interface between a central processing unit and a display of said portable electronic device.

27. The method of claim 21 wherein said location detector module monitors said on-screen registers for said register write operation from a central processing unit of a host electronic device.

28. The method of claim 27 wherein said central processing unit prepares for said transfer operation by programming said on-screen registers to define said memory storage locations for said on-screen data.

29. The method of claim 27 wherein said location detector module determines that said central processing unit has performed said register write operation to modify said on-screen registers and said memory storage locations of said on-screen data in said video memory, said on-screen data including main window data and picture-in-picture data.

30. The method of claim 21 wherein said location detector module determines that said register write operation has occurred within said on-screen registers by comparing current on-screen register information with prior known on-screen register information.

31. The method of claim 21 wherein said on-screen registers store on-screen information for defining said memory storage locations, said on-screen information including a main window start address, a main window stride, a main window height, a picture-in-picture window start address, a picture-in-picture window stride, and a picture-in-picture window height.

32. The method of claim 21 wherein said on-screen registers store on-screen information for defining said memory storage locations, said on-screen information including a main window color-depth register for defining a bit-per-pixel parameter for said main window data, said on-screen information also including a picture-in-picture window color-depth register for defining a bit-per-pixel parameter for said picture-in-picture data

33. The method of claim 21 wherein said location detector module determines that said register write operation has occurred to a main window start address in said on-screen registers, said location detector module responsively setting said transfer flag.

34. The method of claim 21 wherein said location detector module determines that said register write operation has occurred to a main window stride in said on-screen registers, said location detector module responsively setting said transfer flag.

35. The method of claim 21 wherein said location detector module determines that said register write operation has occurred to a main window height in said on-screen registers, said location detector module responsively setting said transfer flag.

36. The method of claim 21 wherein said location detector module determines that said register write operation has occurred to a picture-in-picture window start address in said on-screen registers, said location detector module responsively setting said transfer flag.

37. The method of claim 21 wherein said location detector module determines that said register write operation has occurred to a picture-in-picture window stride in said on-screen registers, said location detector module responsively setting said transfer flag.

38. The method of claim 21 wherein said location detector module determines that said register write operation has occurred to a picture-in-picture window height in said on-screen registers, said location detector module responsively setting said transfer flag.

39. The method of claim 21 wherein said controller logic detects that said location detector module has set said transfer flag, said controller logic responsively initiating a full frame transfer of said on-screen data from said video memory to said data destination, said full frame transfer being automatically performed by an automatic transfer module of said controller logic, said full frame transfer alternately being manually performed by a central processing unit of a host electronic device.

40. The method of claim 21 wherein said location detector module supports a dual buffering scheme in which a central processing unit alternately writes frames of image data into two different areas of off-screen data in said video memory, each most-recently written one of said frames of said image data then being alternately transferred to said data destination as said on-screen data when said transfer flag is set, said location detector module also supporting an animation process in which said central processing unit simultaneously writes a series of said frames of said image data into said off-screen data, said controller logic then sequentially transferring individual frames from said series of frames to said data destination as said on-screen data when said transfer flag is set.

41. A system for handling electronic information, comprising:
means for detecting a write operation to on-screen registers that define memory storage locations for on-screen data in a video memory;
means for responsively setting a transfer flag to indicate that said on-screen registers and said memory storage locations for said on-screen data have been modified; and
means for initiating a transfer operation for transferring said on-screen data from said video memory to a data destination whenever said transfer flag has been set.

42. A system for handling electronic information, comprising:
a location detector module for detecting that a memory storage location of data has been modified, said location detector module responsively setting a transfer flag; and
controller logic that initiates a transfer operation for transferring said data to a data destination whenever said transfer flag has been set by said location detector module.
